(19) United States
(12) Patent Application Publication
(10) Pub. No.: US 2016/0335898 A1
(43) Pub. Date: Nov. 17, 2016

(54) AUTOMATED DRONE MANAGEMENT SYSTEM

(71) Applicant: VULCAN, INC., Seattle, WA (US)

(72) Inventors: Alan Caplan, Seattle, WA (US); Andrew Hicki, Issaquah, WA (US); Keith Rosema, Seattle, WA (US)

(73) Assignee: VULCAN, INC., Seattle, WA (US)

(21) Appl. No.: 15/096,077

(22) Filed: Apr. 11, 2016

Related U.S. Application Data
(60) Provisional application No. 62/145,420, filed on Apr. 9, 2015.

(51) Int. Cl. G08G 5/00; G08G 5/04; B64C 39/02; H04M 1/725

(52) U.S. Cl. CPC G08G 5/006; H04M 1/72527; H04M 1/72572; G08G 5/0017; G08G 5/0069; G08G 5/045; B64C 39/024; B64C 2201/141; B64C 2201/146

(57) ABSTRACT

The current document is directed to a system that allows drone operators to confine drone flights to safe flight areas that are computed automatically or specified by an end user. Certain implementations of the system focus on consumer applications while others allow commercial and municipal users to define safe conduits within urban, rural and industrial areas.

### CROSS-REFERENCE TO RELATED APPLICATION

This application claims the benefit of Provisional Application No. 62/145,420, filed Apr. 9, 2015.

### TECHNICAL FIELD

The current document is directed to an easy-to-use system that allows consumers to operate drones within machine-customized or user-customized safe areas to prevent collisions and regulatory violations.

### BACKGROUND

Sales of consumer drones are skyrocketing. Amazon sold more than 10,000 drones per month in late 2014 and the Consumer Electronics Association estimates that 2015 consumer sales will exceed $130,000,000 and 400,000 units. Unfortunately, a significant portion of these sales lead to disappointed purchasers and damaged or destroyed drones. Piloting a consumer drone is surprisingly difficult and, as anecdotally documented on YouTube, many flights come to an untimely end in the branches of trees, on the walls of houses and buildings, and in power lines.

The FAA is concerned by consumer ignorance of, and inability to comply with, flight safety regulations. To prevent collisions, the agency restricts recreational and commercial drone flights to operator-line-of-site at altitudes less than 400 feet. These regulations inhibit many highly anticipated and valuable commercial drone applications. Despite these restrictions, reported drone/aircraft interactions currently occur at a rate of more than 40 per month. Until systems are developed that protect aircraft, property, and civilians, the FAA will likely continue to drastically curtail non-governmental drone use.

### SUMMARY

The current document is directed to a system that allows drone operators to confine drone flights to safe flight areas that have been either algorithmically computed or identified by an end user. Certain implementations of the system focus on consumer applications while others allow commercial and municipal users to define safe conduits within urban, rural and industrial areas.

### BRIEF DESCRIPTION OF THE DRAWINGS

FIG. 1 shows the main components of the currently disclosed system.

FIG. 2 provides a workflow for one implementation of the currently disclosed system.

FIG. 3 illustrates a method for generating safe-flight volumes from image and data maps.

FIG. 4 illustrates a method for inferring a database of no-fly zones from permanent and temporary flight restrictions.

FIG. 5 illustrates a method for merging potentially contradictory databases of flight restrictions.

FIG. 6 illustrates a method for assessing risk of operating aircraft in a predefined geographic region.

FIG. 7 illustrates a method for communicating multiple types of information about safe-flight volumes to aircraft.

FIG. 8 illustrates semi-autonomous control of a drone based on interoperation between safe-flight database and an aircraft flight controller.

FIG. 9 illustrates a method for recording flight data from aircraft.

FIG. 10 illustrates a method for validating captured feedback from a client interface.

FIG. 11 illustrates a method for integrating feedback into a system for inferring safe-flight volumes.

FIG. 12 provides a diagram of the architecture of one implementation of the currently disclosed system.

### DETAILED DESCRIPTION

The current document is directed to an easy-to-use system that allows consumers to operate drones within customized safe areas to prevent collisions and regulatory violations.

In one implementation, the system comprises of a smartphone application that that interfaces with (1) the drone's on-board Flight Control systems and (2) a network-based service that supplies information about where it is currently safe to fly the drone. In this embodiment, when a user intentionally or inadvertently attempts to steer a drone across a boundary or into an obstacle, the system overrides the instruction and maintaining control of the drone within permitted airspace.

In this embodiment, the smartphone application ensures interfaces with the drone's flight control system to ensure that drones (1) fly within algorithmically-computed and/or user-indicated safe-flight boundaries, (2) limit their flight to legal areas, and (3) automatically avoid identified obstacles.

This smartphone application also allows users (4) to browse safe-flight areas, (5) to assess the risk associated with flying in a specific area, and (6) report obstacles and other hazards in safe-flight areas. This application also provides users with a novel method for controlling drone flight that uses user-specified boundaries to ensure that a drone follows a desired trajectory.

In this embodiment, the smartphone application interacts with a network-based service that maintains a map containing safe-flight boundaries, including those (1) computed automatically by a service, (2) specified by users of the system, and (3) derived from regulations and other flight area restrictions provided by the FAA and other regulatory bodies. This network-based service also includes components that provide relevant contextual information (such as weather conditions, weather forecasts, and visibility conditions) that could impact safe flight operations in a region. This network-based service also includes components that dynamically update safe-flight boundaries in real-time based on available data (such as contextual information, imagery, map data, past flight histories, sensor payloads, and user input).

This network-based service transmits relevant information to the smartphone application, and receives and stores information about users' past flight information. The system provides commercial users and municipalities with the ability to designate, and in some implementations monitor and enforce, safe corridors for personal, commercial, and governmental drone operations.

Capabilities of various implementations of the currently described system include: (1) inference of safe-flight regions from GIS data; (2) storage of information about safe-flight regions in a Web-hosted database; (3) provision of selected safe-flight regions to a mobile application that works in concert with a flight controller application on a mobile device; (4) creation of a user interface that allows users to visualize the boundaries of safe-flight regions in a mobile application or through an Internet interface; (5) use of a mobile application to ensure that a drone stays within the safe-flight region, despite a user's efforts to fly it out of the region; (6) upload of data from the drone's flight controller to a database; (7) browsing data associated with safe-flight regions and past flights via an internal Web portal.

One implementation of the system includes: (1) a Data Services/Application Layer, a set of core services that uses multiple types of data, including GIS, flight history, and airspace restrictions, to compute regions where drones can operate safely; (2) a User Interface that allows the boundaries of safe-flight regions to be rendered as layers on map tiles, which are used to source map data for Web and mobile applications; (3) Client Application/Services—a mobile application that works in concert with a drone's native Flight Controller application and that is responsible for collecting information about safe-flight regions to a safe-flight database, ensuring that the drone does not fly outside of the safe-flight region, and uploading information about the drone's past flights to a flight-history database; (4) Web Apps that comprise a Web portal that allows developers and customers to browse map data associated with safe-flight regions and past flights made by themselves and other drone pilots.

### System Description

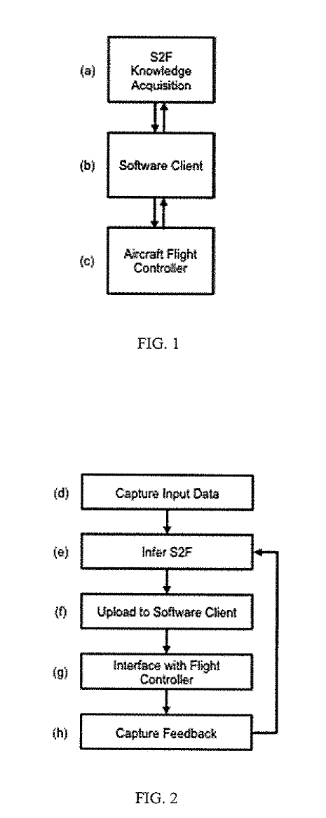

FIG. 1 shows the main components of the currently disclosed system. The system (a) employs a number of server-side components to identify regions where drones can be operated safely, referred to as “safe-flight volumes.” Once computed, information about these regions is sent to a module (b) that interfaces with a drone's flight controller (c) in order to keep the drone from leaving a safe-flight region. A client gathers feedback to be used to improve the performance of the system, including direct feedback from end users and indirect flight data captured by drones.

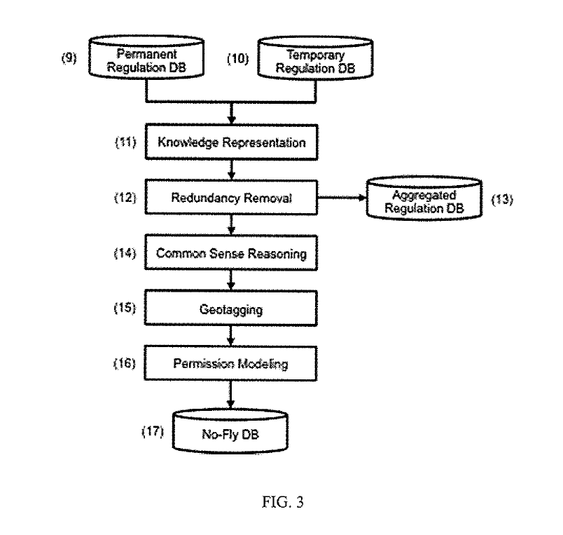

FIG. 2 provides a workflow for one implementation of the currently disclosed system. The system infers (e) safe-flight volumes from various types of information (d) and (h) which is uploaded (f) to the client that interfaces (g) with the Flight Controller. Implementations that integrate feedback into their workflow are not only able to improve the quality of information sent to an aircraft, but are also able to adapt to changing conditions in real-time.

FIG. 3 illustrates a method for generating safe-flight volumes from image and data maps. Certain implementations of the system infer safe-flight volumes from multiple inputs, including (1) imagery (captured from ground-, aircraft-, and satellite-based visual spectrum and/or infrared (IR) cameras; and (2) cartographic and topographic features extracted from maps, and quantitative data collected from integrated sensor systems, including sonar, LiDAR, and RADAR systems. Imagery (1) and map metadata (2) are first sent to a Geospatial Fusion module (3) that synchronizes multiple resources based on a common coordinate representation. Features are then extracted by an Attribute Extraction module (4) and are sent to a pipeline of three inference-based modules. The Altitude Inference (5) infers the minimum and maximum altitudes that a drone can be expected to safely operate within. The Boundary Inference (6) module segments geographic areas into areas where drones can operate safely and where they cannot be operated safely. Finally, the Obstacle Inference module (7) identifies potential obstacles that the drone must avoid within each safe-flight volume. Output from the system is stored in a database, known as the Candidate Safe-Flight Database (8).

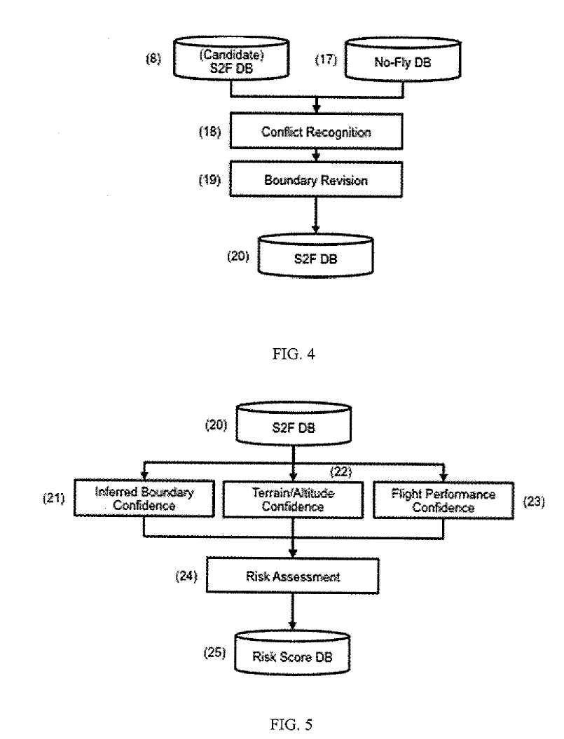

Some implementations of the currently disclosed system leverage a database that captures data that represents spatial volumes where drones cannot be flown legally. FIG. 4 illustrates a method for inferring a database of no-fly zones from permanent and temporary flight restrictions. Information extracted from a semi-structured corpus of permanent flight restrictions (9) and temporary flight restrictions (10) are stored in separate databases. Information from these databases is then sent to a Knowledge Representation module (11), which extracts relevant knowledge from the flight restrictions and represents the relevant knowledge in a structured format that is then reasoned over. These structured representations are then sent to a Redundancy Removal module (12), which identifies and removes features that are overtly duplicates or entail the content of another record. The output of this module is then stored in a separate database (13). Knowledge is then sent to a Common Sense Reasoning module (14) that leverages a probabilistic reasoning capability to identify and fill gaps in the available structured knowledge. For example, if five out of six hospitals in a municipality are covered by an explicit permanent flight restriction and the region surrounding the 6th hospital is also covered by an explicit flight restriction, the system infers an analogous flight restriction for the bth hospital automatically. The no-fly areas output by the Common Sense Reasoning module (14) is then geotagged with latitude, longitude, and altitude information by a Geotagging module (15) and any rights granted to law enforcement or other special classes of users are also captured as metadata by a Permission Modeling module (16). Data is then stored in a No-Fly Database (17) that is integrated with other components or published to third parties.

Certain implementations of the currently disclosed system include systems for cross-referencing the safe-flight volumes generated by the above described method for generating safe-flight volumes from image and data maps with information stored in a no-fly database generated by the above-described method for inferring a database of no-fly zones.

FIG. 5 illustrates a method for merging potentially contradictory databases of flight restrictions. Safe-flight volumes from an initial safe-flight database are intersected with no-fly zones stored in a no-fly database. Model checking-based systems for recognizing intersecting and/or conflicting regions (18) and an automated system for recomputing safe-flight boundaries (19) are employed to integrate safe-flight-volume and no-fly-zone data. Safe-flight volumes are then stored in a final safe-flight database (20).

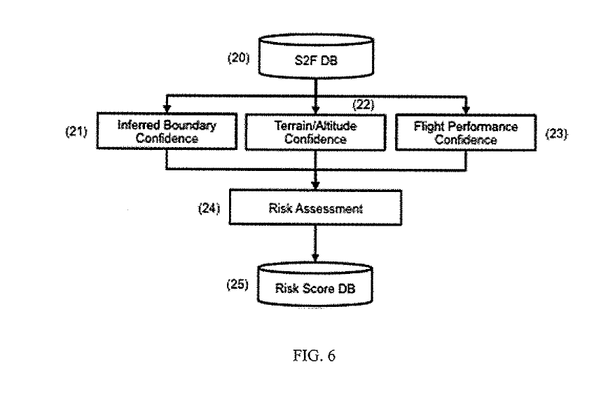

Drones operating in safe-flight volumes face significantly fewer risks than drones operating elsewhere. However, since safe-flight volumes are generated automatically, there are few safe-flight volumes where a drone faces no risk whatsoever. Some implementations of the currently disclosed system include systems for assessing the risk of operating within a geographic region, whether designated safe-flight or not. FIG. 6 illustrates a method for assessing risk of operating aircraft in a predefined geographic region. This method takes, as input, the geographic regions stored in (20) that are designated safe- (or not-safe-) to fly. Three types of features are then considered by a Risk Assessment module: (1) the confidence estimates (21) output by boundary and obstacle recognition modules; (2) confidence estimates (22) associated with features extracted by altitude recognition and visual processing (4) modules; and (3) confidence assessments (23) extracted from the past flight performance of the aircraft. These confidence estimates are then compiled into an aggregate Risk Assessment score (24) and stored per geographic area in a Risk Score database (25).

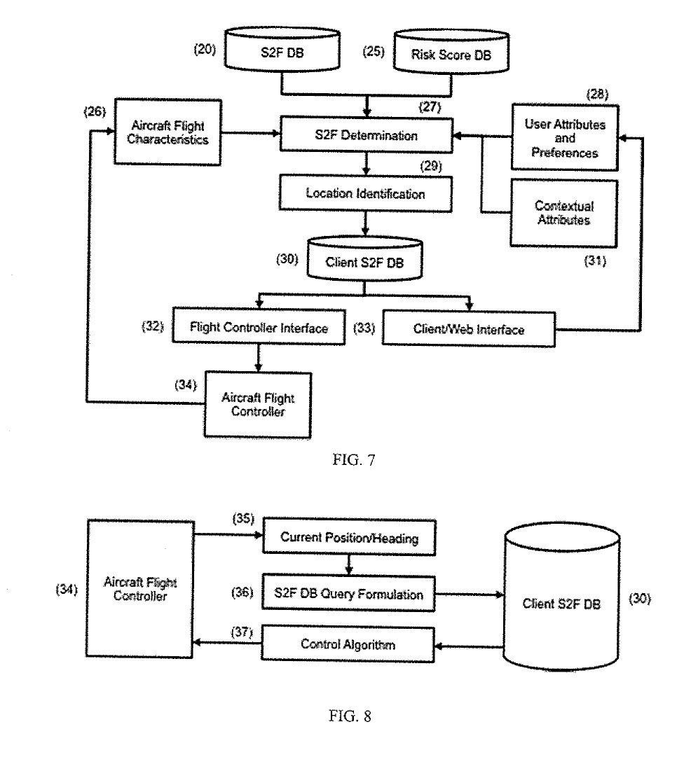

Semi-autonomous control of a drone requires that an intelligent system communicate directly with the flight controller of the aircraft. FIG. 7 illustrates a method for communicating multiple types of information about safe-flight volumes to aircraft. The method incorporates multiple types of information in their communications, including: information about the geographic extent of safe-flight regions (20), the risks associated with flying in a particular region (25), and the preferences of the user currently piloting the aircraft (28). Information from the safe-flight Database (20) and the Risk Score Database (25) are combined by a safe-flight Determination module (27) that assess the current risk of flying the current aircraft in a particular geographic region, given current conditions (31) and a user's stated preferences (28). When the module embodied in (27) deems that safe operation is possible in the current location (identified by (29)), then the system sends information about safe operation in the current location to a Client safe-flight database (30), which interfaces directly with the aircraft's Flight Controller (34) either through a firmware interface (32) or through an application or Web-based interface (33).

FIG. 8 illustrates semi-autonomous control of a drone based on interoperation between safe-flight database and an aircraft flight controller. Software (35) polls the Flight Controller (34) for the aircraft's current position and heading. Position and heading information is sent to a module (36) that queries the client-side safe-flight DB (30). This information is passed to a Control Algorithm (37). When the aircraft's current heading is expected to keep it well-clear of any boundary and/or obstacle stored in the safe-flight database (30) for a predefined period of time, then the Control Algorithm (37) does not intervene and returns to polling (35) at a particular interval. When the Control Algorithm (37) determines that a potential intersection with a boundary is possible, then the Control Algorithm polls more frequently. When collision with a boundary is imminent, then the Control Algorithm (37) takes control of the drone from a user and sends instructions to the Flight Controller (34) to keep the drone away from the boundary. Once the Control Algorithm (37) determines that the drone is clear of the boundary, the Control Algorithm hands control of the drone back to the end user and resumes the process started by (35).

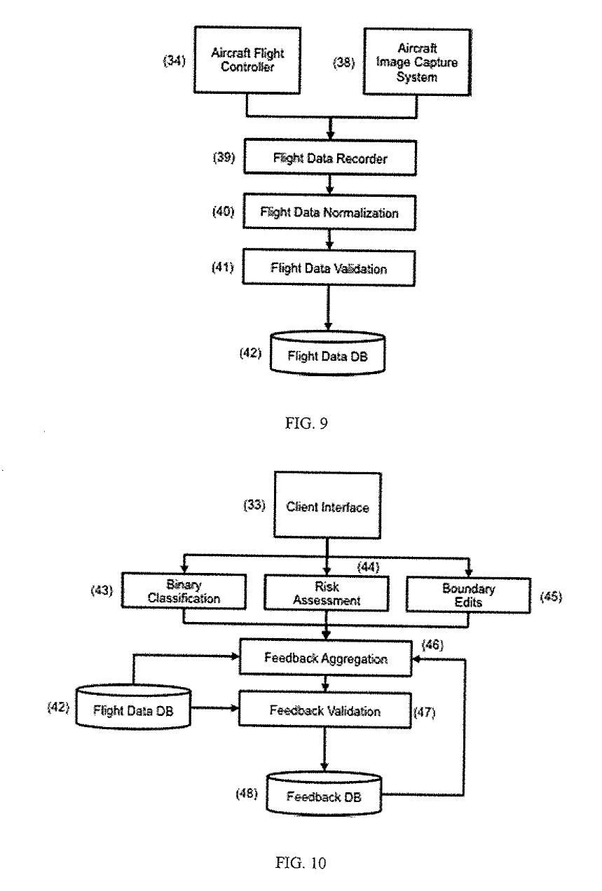

Some implementations of the currently disclosed system leverage systems for capturing flight data from the aircraft in order to improve the quality of their systems for computing safe-flight volumes. FIG. 9 illustrates a method for recording flight data from aircraft. Data from the Flight Controller (34) and/or data from any onboard camera (38) are sent to a Flight Data Recorder (38). The system normalizes the flight data to a common representation (40) and validates whether the normalized data is a valid instance of a flight (41). Data is exported to a Flight Data database (42).

FIG. 10 illustrates a method for validating captured feedback from a client interface. In some implementations, data from the method discussed with reference to FIG. 9 is combined with multiple kinds of feedback captured from end users of a client, such as a drone control interface, a mobile application, or a Web application. These implementations capture three kinds of feedback from these interfaces, including: (1) binary feedback (43) designating whether or not a safe-flight volume was computed correctly; (2) quantitative risk assessments (44) designating how risky operating the user believes that in a particular geographic area was (for flights that have happened previously) or would be (for flights that have not happened yet); and (3) manual edits to the safe-flight boundaries (45) computed by the system. The feedback is integrated along with data collected into a Flight Data database (42) into a Feedback Aggregation module (46). This module unifies positive and negative feedback associated with each safe-flight region. Potentially incorrect and/or contradictory feedback is then weeded out by a Feedback Validation module (47) before begin stored in a standalone database (48).

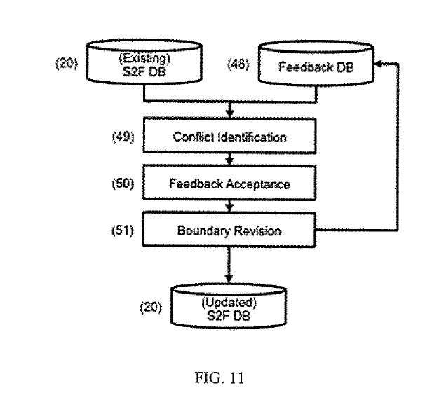

FIG. 11 illustrates a method for integrating feedback into a system for inferring safe-flight volumes. Data from a safe-flight database (20) and a feedback database (48) are input to a Conflict Identification module (49) that flags safe-flight volumes in need of improvement. This module (49) generates hypotheses corresponding to potential improvements, which are then sent to a reasoning-based Feedback Acceptance module (50), which either rejects or accepts the edits suggested by (49). Accepted revisions are then sent to a Boundary Revision module (51), which identifies additional discrepancies or conflicts within the model. Updated boundaries are then stored in a new version of the safe-flight database (20), while a comprehensive record of all of the edits suggested and made by the Feedback Acceptance module (50) and Boundary Revision module (51) are stored as feedback in the Feedback database (48).

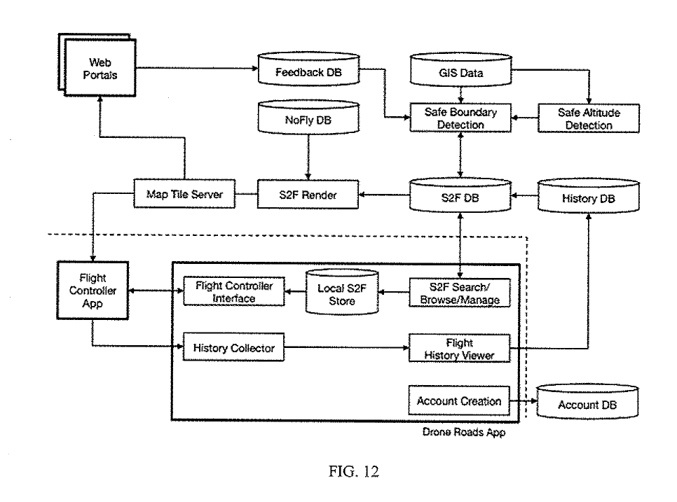

FIG. 12 provides a diagram of the architecture of one implementation of the currently disclosed system. Users initially interact with the mobile application by creating an account, using an Account Creation service. Credentials are stored on the server-side in an Account Database. Account creation involves verification, via email or SMS, in order to ensure that only valid accounts are stored. Once authenticated, users can view details of their past flights, using a Flight History Viewer interface provided by the mobile application. Users can browse, search, and download safe-flight areas for their upcoming flights. Downloaded safe-flight regions are stored locally in a local safe-flight store and are passed to a Flight Controller interface responsible for sending the instructions necessary to keep the drone operating in the safe-flight region. The mobile application is also responsible for fetching flight history data from the Flight Controller and uploading it to a Flight History database. On the server side, GIS data and associated map tiles are consumed by a pair of Safe Boundary Detection and Safe Altitude Detection modules. Output from these modules is stored in a safe-flight database along with data from past successful flights captured from the mobile apps. Information about safe-flight regions is then sent to a safe-flight rendering module, which displays the boundaries of the safe-flight regions, boundaries of no-fly zones and other associated metadata on map tiles. These map tiles are pre-rendered and are served to our Web applications and mobile applications on an on-demand basis by a Map Tile Server.

Data from safe-flight servers, no-fly servers, and the Map Tile Server is also shared with Web applications, which include an administration interface for internal development and a customer portal that allows users to browse and provide feedback on the safe-flight and no-fly regions plotted on map tiles. Feedback collected from these portals is stored in a feedback database and eventually integrated into Boundary Detection and Altitude Recognition modules.

### Additional Functionality and Enhanced System Capabilities

In some implementations, operators are required to use the currently disclosed system by drone owners, property owners, or government bodies. In one such implementation, the required-use function consists of a component in the flight control system that confirms that the currently disclosed system is active as a condition for the drone's entering (or maintaining) a ready state or a flight state. In another such implementation, the required-use function consists of a physical component located on the drone that is connected to the flight control system and that confirms that currently disclosed system is active as a condition to the drone's entering (or maintaining) a ready state or a flight state. In another such implementation, the required-use function is conditional based on a variety of factors, such as location, user identity of qualification, time of day, or weather. In such instances, the system contains a data store of conditional requirements and an additional function that periodically or continuously assesses current conditions, performs a check against the stored conditional requirements to determine whether there are any in force, and then executes the required use function as appropriate.

In one implementation, the system permits a single operator to fly multiple drones within a designated flight area. In such implementation, the currently disclosed system includes an interface that simultaneously communicates with the flight controller applications of at least two drones.

Some implementations of the system permit multiple operators to safely fly drones within a particular flight area. In one such implementation, the mobile application includes additional functions that identify additional drones operating in the relevant safe-flight area, divide the relevant safe-flight area into multiple flight sectors, assign the drone in question to a particular safe sector, and add that information to the local safe-flight store. In another implementation, the currently disclosed system includes additional functions that identify additional drones operating in the relevant safe-flight area, create multiple flight paths within the relevant safe-flight area, assign the drone in question to a particular flight path, and add that information to the local safe-flight store. In a third implementation, the currently disclosed system includes additional functions that identify additional drones operating in the relevant safe-flight area, create and maintain dynamic boundaries around the drone in question and the additional drones, and add boundary information to the local Safe-flight Data Store.

Some implementations of the currently disclosed system create all or portions of flight routes. For example, one implementation includes a user interface module that permits the operator to specify an origination point and a destination point, a route-plotting function that calculates one or more routes that connect those points without exiting the relevant safe-flight area or crossing any obstacle boundaries, and a communication mechanism that conveys the route information to the drone's Flight Controller application. In another implementation, a user-interface module permits the user to specify a takeoff/landing site within the user's property that is available for use by other drone operators, which information is conveyed to the Safe-flight Data Store for subsequent safe-route plotting.

Some implementations of the system specify routes or other useful behaviors relating to specific applications. One such implementation includes: (1) a data store of available applications and, for each available application, a set of desired missions and relevant behavioral criteria; (2) a user-interface component that presents application and mission options to the user; (3) a route plotting function that selects safe routes that satisfy the applicable behavioral criteria; and (4) a communication mechanism that conveys the route information to the drone's Flight Controller App.

Some implementations of the system include a software development kit that contains tools enabling third parties to design task-specific applications or games and a communication mechanism that transmits those third-party applications to the system's central store of available applications for selection and use by system users.

Some implementations of the system allow users to automatically generate roads within specific geographies based on various criteria. One such implementation includes: (1) a user interface that allows users to identify a relevant geographical area, to identify the number of desired safe-fly routes within the identified geographic area, and to select among various possible characteristics of safe-fly routes within the identified geographical area; (2) a route-plotting function that calculates routes within the geographical area; and (3) a communication mechanism that transmits the route information to the system

### Safe-Flight Data Store

Some implementations of the system permit users to identify geo-fence boundaries or geo-fenced obstacles by using gestures. In one such implementation, the currently disclosed system App is hosted on a remote computing device and contains: (1) an interface to the device's motion sensors to determine, based on the user's pointing the device in a specific direction, a general location of interest; (2) an interface to the device's visual, radio, or other sensors to identify potential obstacles within the general location of interest; (3) a user interface that displays potential obstacles to the user and allows the user to select one or more such obstacles; (4) a boundary-calculation function that determines safe-fly boundaries around the selected obstacles; and (5) a communication mechanism that transmits the safe-fly boundaries to the system Safe-flight Data Store.

Some implementations of the system allow boundaries and no-fly zones to be conditional based on various criteria. In such implementations, the system Safe-flight Data Store tables have an additional column or columns for relevant conditional criteria which are communicated along with other safe-flight data to the mobile application and the mobile application has a function that compares applicable conditional criteria to then-current conditions, for example, the user's account profile and the time of day, and determines which conditional criteria are applicable to the then-current flight conditions. Such conditional criteria then are transmitted to the mobile application Safe-flight Search/Browse/Manage component.

Some implementations of the system permit users to view boundaries and other information, like permission requirements and tolls, as elements in an augmented reality display. One such implementation contains an augmented-reality display engine which obtains boundary and obstacle information from the System Safe-flight render function, obtains visual information from the remote hosting device's camera, creates virtual objects from the boundary and obstacle information, combines the virtual objects with the visual information; and displays the combined imagery on the remote hosting device's display screen or other display mechanism.

### Social and Community Features

Some implementations of the system allow users to submit comments and ratings regarding flight areas and experiences. One such implementation includes: (1) an interactive data store that contains comments, reviews, and other information associated with particular geographical locations; (2) a user interface that allows users to submit comments, reviews, and other information which is then associated with relevant geographical locations; (3) a search/browse/manage function that identifies stored information that is associated with a relevant geographical location; and (4) a display function that displays such information to the user.

Some implementations of the system permit users to post and exchange information regarding their flight experiences, such as photos and videos. One such implementation includes: (1) an interactive data store that associates submitted information with user profiles and other relevant metadata (such as, for example, time and location); (2) a user interface that allows users to submit information to the interactive data store; (3) a user interface that allows users to search and browse the interactive data store; (4) a search/browse/manage function that identifies stored information that is responsive to a user's query or browse activity; and (5) a display function that displays such responsive information to a querying or browsing user.

Some implementations of system permit users to share their own routes and to re-fly the routes of others. One such implementation includes: (1) an additional column within the system History Data Base that indicates whether specific flown routes are private or sharable; (2) a user interface that enables a user who flies a route to designate whether the route is private or sharable; (3) a display mechanism that indicates the shared routes that are applicable to a specific geographical location; (4) a user interface that permits a user to select an available previously flown route; and (5) a communication mechanism that transmits the selected route to the Flight Controller App.

### Commerce Features

Some implementations of the system serve contextual advertisements and other information to users based on their current location, activities, preferences, and other personal information. One such implementation includes: (1) an interactive-data store that contains advertisements and other information and that associates such advertisements and other information with relevance criteria, such as locations, activities, and user characteristics; (2) a characteristic extraction function that, for a particular user at a particular time, identifies characteristics or circumstances that may be useful to selecting relevant advertisements and/or other information; (3) a search/browse/manage function that selects those stored advertisements and/or other information that are appropriate for display to the user; and (4) a display function that displays the selected advertisements and/or other information to the user.

Some implementations of the system permit the system operator (or third parties) to insert virtual objects into flight areas, such as advertisements, product placements, and game-related items. One such implementation includes: (1) an interactive data store that contains virtual objects and that associates such virtual objects with relevance criteria, such as (for example) locations, activities, and user characteristics; (2) a characteristic extraction function that, for a particular user at a particular time, identifies characteristics or circumstances that may be useful to selecting relevant virtual objects; (3) a search/browse/manage function that selects those virtual objects that are appropriate for display to the user; and (4) a rendering engine that obtains visual information from the remote hosting device's camera, combines the selected virtual objects with the visual information, and displays the combined imagery on the remote hosting device's display screen or other display mechanism.

It is appreciated that the previous description of the disclosed embodiments is provided to enable any person skilled in the art to make or use the present disclosure. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein, but is to be accorded the widest scope consistent with the principles and novel features disclosed herein.

1. A safe-drone-operation system comprising:
a drone;
a network-based service that supplies information about where it is currently safe and permitted to fly drones and about the locations of obstacles; and
a smart-phone application that executes on a user smart phone, interfaces with an on-board Flight Control system of the drone, and interfaces with the network-based service to
override manual control of the drone to maintain operation of the drone within a permitted airspace,
override manual control of the drone to collision of the drone within a permitted airspace,
provide indications of safe-flight areas, and
receive input indicating obstacles and safe flight areas.
